(19) United States
(12) Patent Application Publication
(10) Pub. No.: US 2002/0147791 A1
(43) Pub. Date: Oct. 10, 2002

(54) System for providing a service to a device in a home network and method thereof

(75) Inventor: Moon-Jeong Choi, Suwon-city (KR)

Correspondence Address: SUGHRUE, MION, ZINN, MACPEAK & SEAS, PLLC, Suite 800, 2100 Pennsylvania Avenue N.W., Washington, DC, 20037-3213, US

(73) Assignee: SAMSUNG ELECTRONICS CO., LTD.

(21) Appl. No.: 09/985,067

(22) Filed: Nov. 1, 2001

(30) Foreign Application Priority Data
Feb. 3, 2001 (KR) 2001-5288

(51) Int. Cl. G06F 15/16

(52) U.S. Cl. 709/217; 709/245

(57) ABSTRACT

A system and method for externally providing a service to a specific device in a home network where a plurality of devices are connected. The system includes a service receiving device which is registered for a service, and a service providing server for transmitting a service message to confirm a service receptiveness of the service receiving device, and providing a corresponding service to the service receiving device upon confirming the service receptiveness of the service receiving device. Accordingly, the devices connected in the home network can receive external services that are provided outside of the home network.

### BACKGROUND OF THE INVENTION

1. Field of the Invention The present invention relates to a method for providing a service via the Internet, and more particularly, to a system for externally providing a service to a specific device in a home network and a method thereof.

2. Description of the Related Art Recently, as communication techniques have been developed, a number of information and communication devices such as a computer, fax, modem or telephone are connected through a network in a relatively small space such as a SOHO (Small Office Home Office).

In addition to the information and communication devices such as the computer, fax, modem or telephone, continuous studies have been made about controlling a home network from an external location, i.e., controlling A/V (Audio Visual) devices such as a TV, DVD (Digital Video Disk), or VCR (Video Cassette Recorder) and consumer devices such as a rice cooker, a refrigerator or a washer that are connected through the network from a location external to a home.

Hereinafter, the network established in the SOHO and the home will be called a home network for ease of explanation.

In an exemplary method of establishing such a home network, a common virtual environment is established, termed middleware, for devices scattered in the house and an application is provided to the middleware.

Examples of a middleware system proposed up to now include UpnP (Universal Plug and Play), HAVi (Home AV interoperability), Jini, Home Wide Web, etc.

HAVi is designed based upon IEEE1394 (Institute of Electrical and Electronics Engineers 1394) and has a problem that inter-networking or mutual communication among networks cannot be suitably realized.

Also, while being able to internetwork using a TCP/IP protocol, UPnP and Jini mainly perform networking between a PC and a PC external device and have difficulty in real time transmitting data (video/audio data) among digital consumer devices.

### SUMMARY OF THE INVENTION

It is an object of the present invention to solve the foregoing problems and accordingly provide a system for providing service to a device in a home network which can transmit data and is capable of internetworking or externally communicating with devices connected in the home network, and a method thereof.

In order to accomplish the above object, a system according to the present invention externally provides a service to a specific device in a home network where a plurality of devices are connected, the system includes a service receiving device which is registered for a service; and a service providing server for providing a service to the service receiving device when confirming a service receptiveness of the service receiving device, the service providing server confirming the service receptiveness of the service receiving device by transmitting a service message to the service receiving device.

The above object is also accomplished by a method according to the present invention for externally providing a service to a specific device of a home network having a plurality of devices connected, including the steps of (i) transmitting a service message to a service receiving device which is an intended recipient of the service to confirm a service receptiveness of the service receiving device; and (ii) providing the service to the service receiving device when confirming the service receptiveness of the service receiving device.

### BRIEF DESCRIPTION OF THE DRAWINGS

The above and other objects and advantages of the present invention will become readily apparent by reference to the following detailed description when considered in conjunction with the accompanying drawings wherein:

FIG. 1 shows the construction of a system for providing a service to a device in a home network according to a preferred embodiment of the present invention;

FIG. 2 shows the construction of the home network shown in FIG. 1;

FIG. 3 shows a push service as an example of a service provided by a remote service providing server shown in FIG. 1, wherein FIG. 3A shows a service for transmitting a news flash in a certain period to a digital TV, and FIG. 3B shows a service for transmitting an information in a certain period to an embedded web refrigerator where a web browser is installed;

FIG. 4 shows an example of a service registration table which is stored in a remote service providing server shown in FIG. 1;

FIG. 5 is a flow chart for showing a service providing process of a remote service providing server;

FIG. 6 is a flow chart for showing a service message transmitting process of an Internet connection providing server;

FIG. 7 is a flow chart for showing a service message transmitting process of a lookup server in the home network;

FIG. 8 shows a signal flow of a method for providing a service to the home network according to a preferred embodiment of the present invention;

FIGS. 9A through 9D show program source code of an example of a master.dtd which is stored in the lookup server; and

FIG. 10A shows source code of a service message, and FIG. 10B shows source code of a service response message.

### DETAILED DESCRIPTION OF THE PREFERRED EMBODIMENT

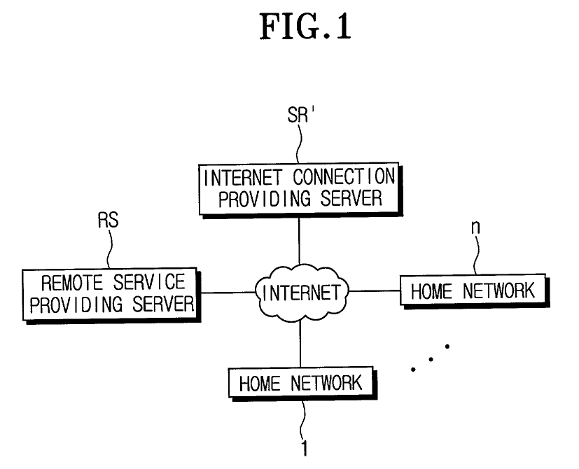

FIG. 1 shows the construction of a system for providing a service to devices in a home network according to a preferred embodiment of the present invention.

As shown in FIG. 1, a remote service providing server RS and an Internet connection providing server SR′ are connected to a number of home networks (1, . . . , n) via the Internet.

The remote service providing server RS exists outside the home networks, and provides services through the Internet. In particular, the remote service providing server RS serves the devices that are connected in the home networks and registered for service with the remote service providing server RS.

The devices in the home networks can register for the remote service providing server RS or cancel the registration on-line or off-line.

The Internet connection providing server SR′ allocates global IP addresses to the home networks, and stores ID (e.g., URL) of the home networks and the global IP addresses allocated to the home networks.

The Internet connection providing server SR′ processes messages provided from the home networks, and processes a service message received from the remote service providing server RS.

The construction of the home networks will be described in detail as follows:

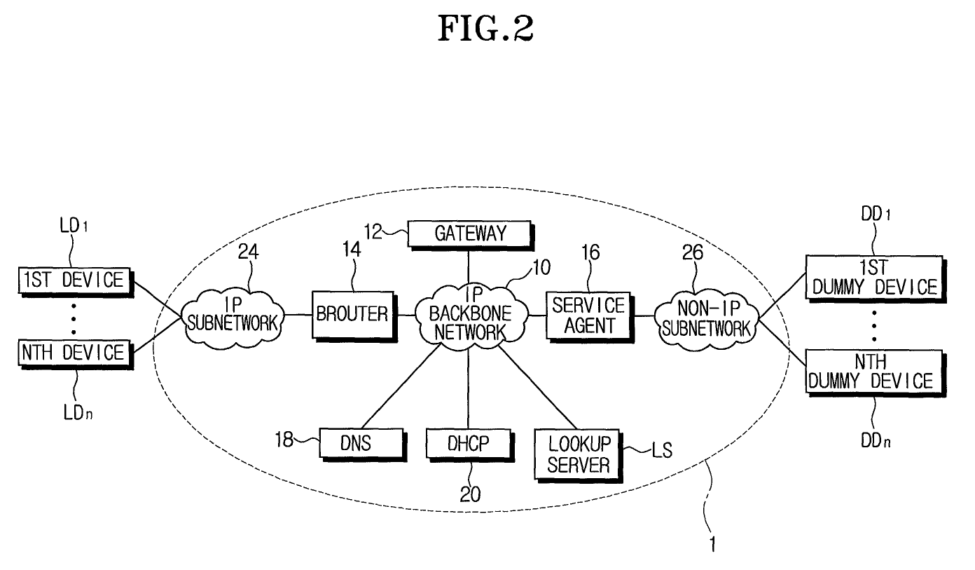

FIG. 2 shows the construction of the home network 1 shown in FIG. 1.

The home network 1 includes an IP backbone network 10, a gateway 12, a brouter 14, a service agent 16, a DNS server 18, a DHCP server 20, a lookup server LS, an IP subnetwork 24, a non-IP subnetwork 26, first to nth devices LD1 to LDn and first to nth dummy devices DD1 to DDn.

The DHCP server 20 provides dynamic IP addresses to the devices in the home network 1.

The home network 1 uses the dynamic IP addresses which are used only in the home network 1 to designate a plurality of devices connected in the home network 1.

The gateway 12 is an entry node for allowing the home network 1 to communicate with other networks including other home networks which are present outside the home network 1.

The DNS server 18 provides a host name to the devices in the home network 1. The host name may employ a default name which is added by a user or previously designated to show functional meanings of the apparatus.

Among the devices in the home network, intelligent devices that are capable of self-control are connected in the IP subnetwork 24.

The brouter 14 is a bridge and a router which is arranged between the IP backbone network 10 and the IP subnetwork 24 to search a path for an IP packet transmitted between the backbone network 10 and the IP subnetwork 24.

Among the devices in the home network, dummy devices such as a lamp, a door or a washer are connected in the non-IP subnetwork. The dummy devices are incapable of self-control but designed to simply perform regulated operations.

The service agent 16 is arranged between the non-IP subnetwork 26 and the IP backbone network 10 to manage a service to the dummy devices.

Also, the service agent 16 is allocated with the dynamic addresses for the dummy devices, which are connected to the non-IP subnetwork 26, from the DHCP 20, respectively, and manages the allocated dynamic IP addresses.

Also, for the dummy devices, the service agent 16 performs a status management on the matter such as whether the dummy devices are powered on or connected to the home network, etc.

Also for the devices connected to the home network, the lookup server LS stores and manages device information of the devices such as device type, vendor, model name, serial number, etc. and other information of the devices such as dynamic address, ID, etc. in a registration table. Such a registration table is updated whenever the construction of the home network is changed.

Table 1 is an example of the registration table of the devices stored in the lookup server LS.

TABLE 1

| IPAddr | LD IPaddress |
|---|---|
| ServiceTypeSerialNum | LD characteristic ID |
| DeviceUserName | User Designating Information |
| | (optional) |
| device[i].deviceType | Ex. TV |
| device[i].manufacturerIcon | Ex.Samsungtv.gif |
| device[i].manufacturerUrl | Manufacturer Homepage URL |
| device[i].modelIcon | Ex.Pavv.gif |
| device[i].modelUrlcontent | Product Model Home URL |
| device[i].modelNum | Model Name |
| device[i].serialNum | Model Serial Number |
| device[i].xmlService[j].object[k] | Used in D2D-level |
| device[i].xmlService[j].command | Command, Can be Performed |
| | in LD |
| device[i].xmlService[j].serviceName | Name, Necessary for Performing |
| | Service in LD |
| device[i].deviceProperty[m].title | Property Name (Ex. Resolution) |
| device[i].deviceProperty[m].content | Property Information(Ex.PM@HL |
| | 1280x720P) |

i, j, k: at least one, m: at least zero

In general, HTML (Hypertext Markup Language) has a fixed tag so that XML (extensible markup Language) is used to compose master.dtd, which will be described later.

Also, the lookup server LS registers ID and a currently allocated common IP address of the home network to the Internet connection providing server SR′ to allow external communication to the home network.

As the lookup server LS stores and manages dynamic IP addresses allocated to the devices in the home network, the devices in the home network may mutually exchange information regardless of a network media interface which is used by each of the devices.

Now, description will be made in detail about the operation of the remote service providing server RS in the system for providing a service to the devices in such a home network.

The remote service providing server RS provides service to the devices in the home network which are registered for service in the remote service providing server RS.

For example, the remote service providing server RS provides a push service that is different from the general services that are provided upon request of the user. The push service is periodically provided to a specific device that is registered for the push service.

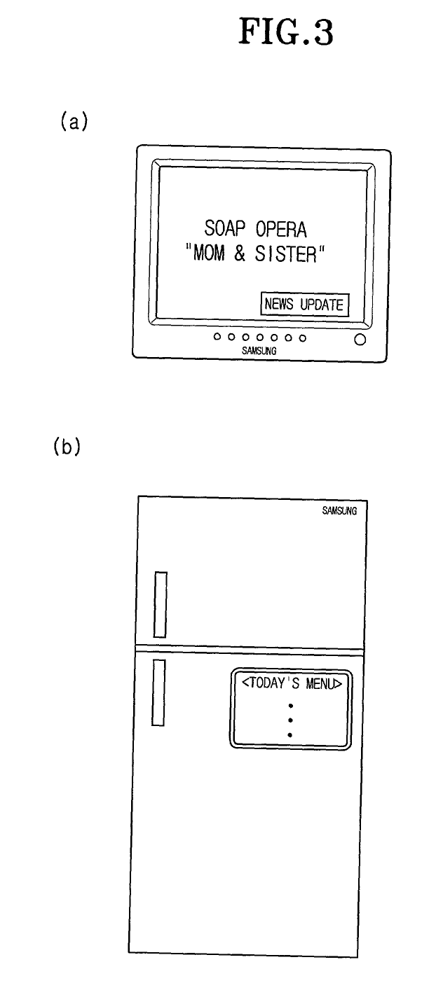

FIG. 3 shows an example of a push service provided by the remote service providing server shown in FIG. 1, wherein FIG. 3A shows a service for transmitting a news update in a certain period to a digital TV, and FIG. 3B shows a service for transmitting information in a certain period to an embedded web refrigerator where a web browser is installed.

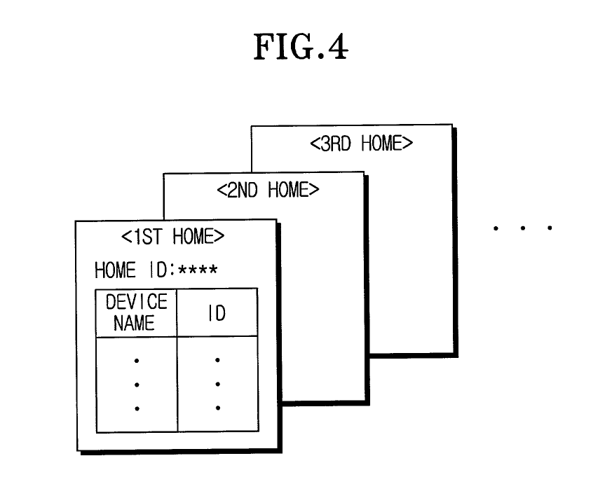

The remote service providing server RS comprises a service registration table of the home network registered for a home service, as shown in FIG. 4.

FIG. 4 shows an example of the service registration table which is stored in the remote service providing server shown in FIG. 1.

As shown in FIG. 4, the service registration table stores IDs of the service registered devices, service items and ID of the home network to which the devices are registered.

Such a service table is upgraded when a specific home network is registered for the service or cancels the registration.

The remote service providing server RS provides service to the devices registered in the service registration table according to the service providing period.

Also, prior to providing service, the remote service providing server RS confirms whether the service receiving device is prepared for a reception of service or not.

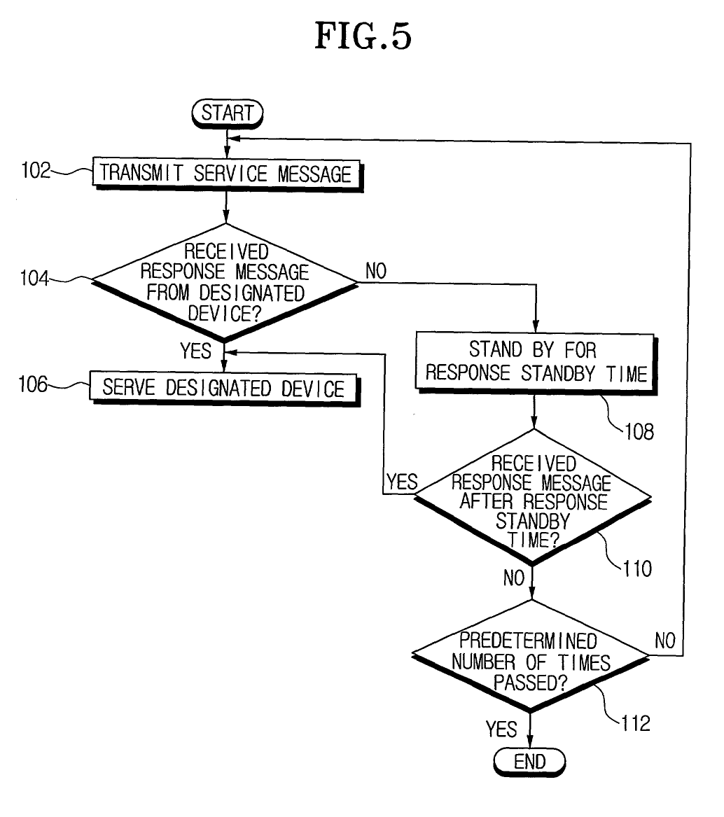

FIG. 5 is a flow chart showing a service providing process of the remote service providing server RS.

First, in step S102, the remote service providing server RS transmits a service message to a service receiving device, i.e., an intended recipient device of the service.

The service message checks the status of the service receiving device, and designates an ID of the service receiving device and an ID of the home network to which the service receiving device is registered. Also, the service message contains an internal program that is operated when the service receiving device receives the service message. Format of the service message will be described later.

Then, the remote service providing server RS confirms if a response message is received from the device designated by the service message, reporting that the device can be served (step S104).

If the received response message reports that the designated device can be served, the remote service providing server provides service to the designated device (step S106).

However, if the response message is not received from the designated device, the remote service providing server stands by for a predetermined response standby time (step S108).

After the predetermined time, the remote service providing server confirms if the response message is received, reporting that the designated device can be served (step S110).

If the response message is received, reporting that the device can be served during the response standby time, the remote service providing server RS provides service to the designated device (step S106).

However, if the response message is not received from the designated device after the response standby time has passed, the remote service providing server RS re-transmits the service message (step S102).

If the response message is not received even after repeating the foregoing steps for a predetermined number of times, the remote service providing server exits the operation for serving.

While FIG. 5 shows one example where the service receiving device does not send a response message when the device is not prepared for the service, the service receiving device may send a response message indicating that the device is not prepared for the service.

Next, a service message transmitting process of the Internet connection providing server SR′ will be described.

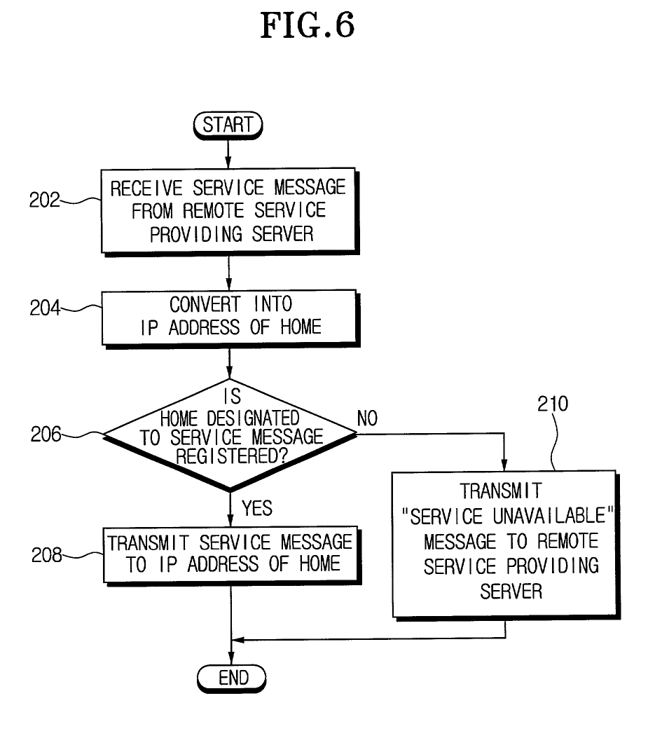

FIG. 6 is a flow chart showing the service message transmitting process of the Internet connection providing server SR′.

The Internet connection providing server SR′ receives the service message from the remote service providing server RS (step S202), and then converts an ID of the home network recorded in the service message to an IP address (step S204).

Then, the Internet connection providing server SR′ confirms if the home network to which the service receiving device is registered is a registered home (or a home having a home network) in the Internet connection providing server SR′ (step S206).

If the home associated with the service receiving device is registered in the Internet connection providing server SR′, the Internet connection providing server SR′ transmits the service message to the IP address of the home (step S208).

However, if the home of the service receiving device is not registered in the Internet connection providing server SR′, the Internet connection providing server SR′ transmits a message mentioning that service is unavailable to the remote service providing server RS (step S210).

Next, a service message transmitting process of the lookup server LS in the home network will be described.

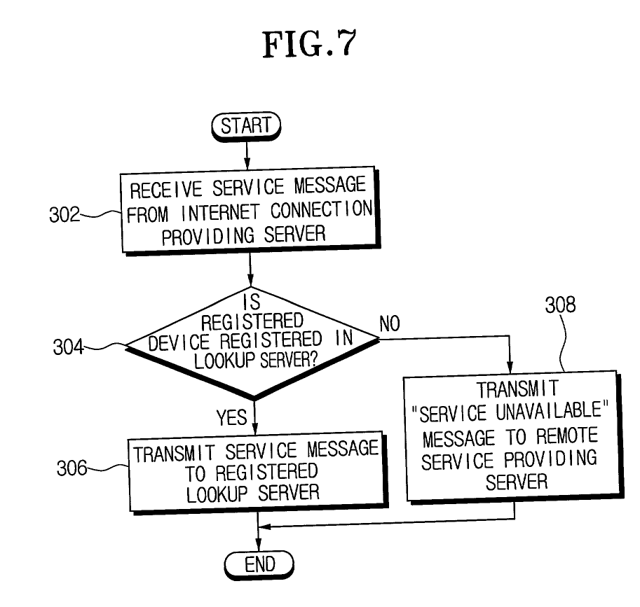

FIG. 7 is a flow chart showing the service message transmitting process of the lookup server LS in the home network.

The lookup server LS in the home network receives the service message which reports ID information of the service receiving device to the IP address of the home corresponding to home ID from the Internet connection providing server SR′ (step S302).

Then, the lookup server LS confirms if the corresponding device is currently registered (step S304), wherein Table 1 is referred to for confirming the service receiving device.

If the service receiving device is confirmed as registered in the lookup server LS, the lookup server LS transmits the service message to a corresponding dynamic address of the service receiving device (step S306).

However, if the service receiving device is conformed as unregistered, the lookup server LS transmits a service unavailable message to the remote service providing server RS (step S308).

Meanwhile, upon receiving the service message mentioning that service will be started, the service receiving device operates the internal program provided from the remote service providing server RS and transmits a response message reporting that preparation is completed for service to the remote service providing server RS.

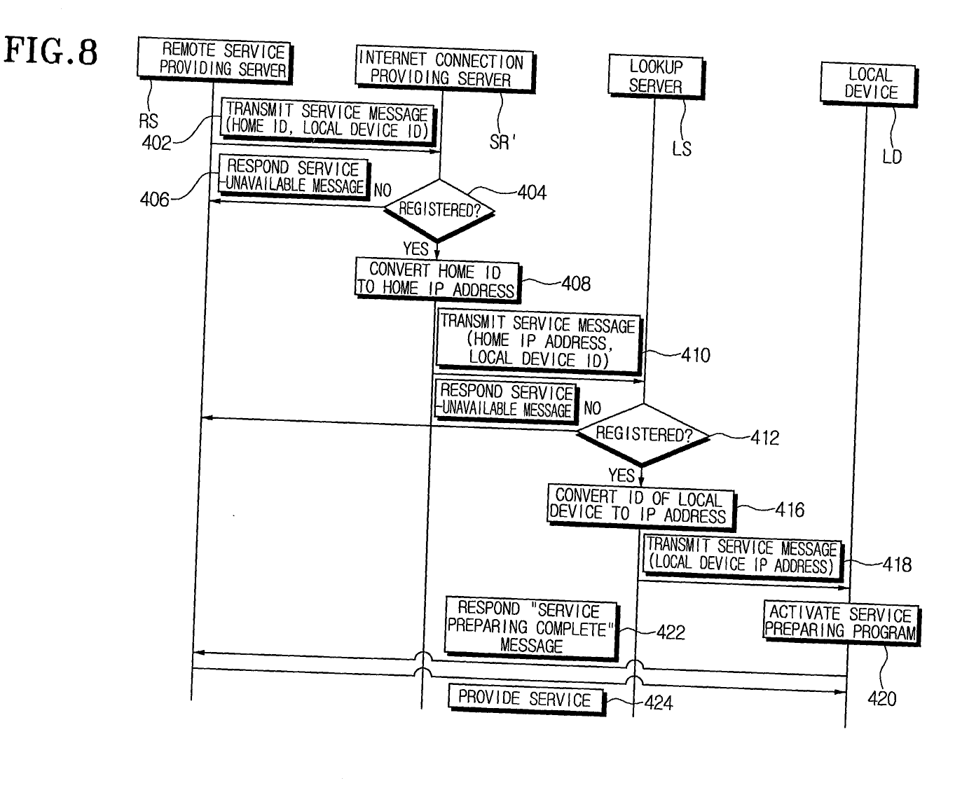

FIG. 8 shows a signal flow of a method for providing a service to the home network according to a preferred embodiment of the present invention.

Referring to FIG. 8, the remote service providing server RS transmits a service message containing an ID of the service receiving device and an ID of the home to which the device is registered to the Internet connection providing server SR′ (step S402).

The Internet connection providing server SR′ receives the service message from the remote service providing server RS and confirms if the home designated in the received service message is registered in the Internet connection providing server SR′ (step S404).

If the home designated in the received service message is not registered in the Internet connection providing server SR′, the Internet connection providing server SR′ transmits a “service unavailable” response message (step S406).

If the home designated in the received service message is registered, the Internet connection providing server SR′ converts the ID of the home designated in the service message to an IP address of the corresponding home (step S408), and transmits a service message containing the ID of the service receiving device and the IP address of the home to which the device is registered to the corresponding home (step S410).

The lookup server LS of the home network receives the service message from the Internet connection providing server SR′, and confirms if the device designated in the received service message is registered in the lookup server LS (step S412).

If the device designated in the received service message is not registered in the lookup server LS, the lookup server LS transmits a “service unavailable” message to the remote service providing server RS (step S414).

However, if the device designated in the received service message is registered in the lookup server LS, the lookup server LS converts the ID of the device designated in the received service message to a dynamic IP address of the corresponding device (step S416), and transmits the service message to the service receiving device (step S418).

Then, the service receiving device activates a service preparing program (step S420), and transmits a message to the remote service providing server RS indicating that preparation is complete (step S422).

Then, the remote service providing server RS provides a corresponding service to the service receiving device (step S424).

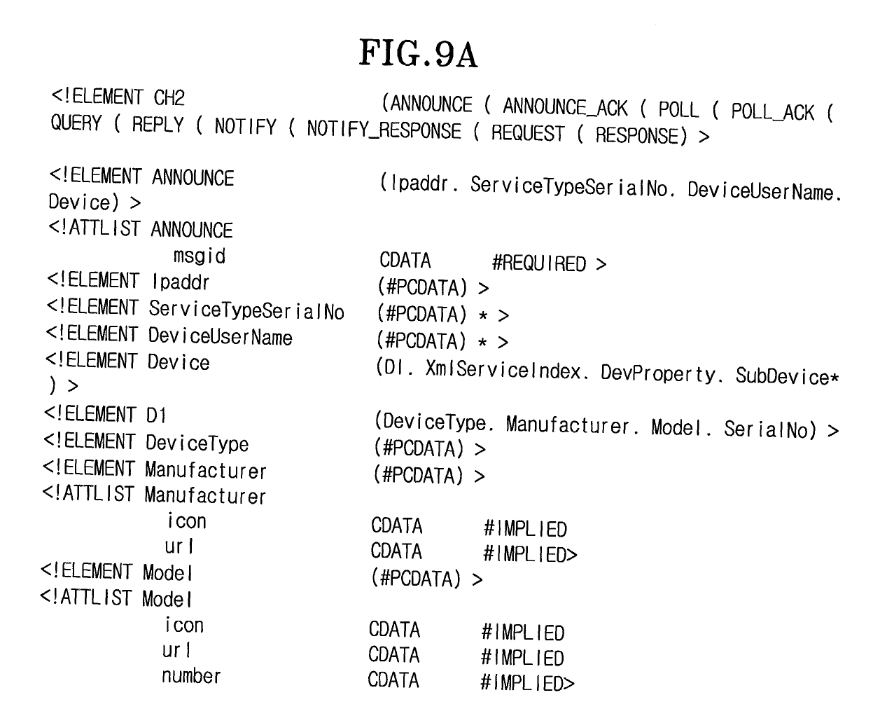

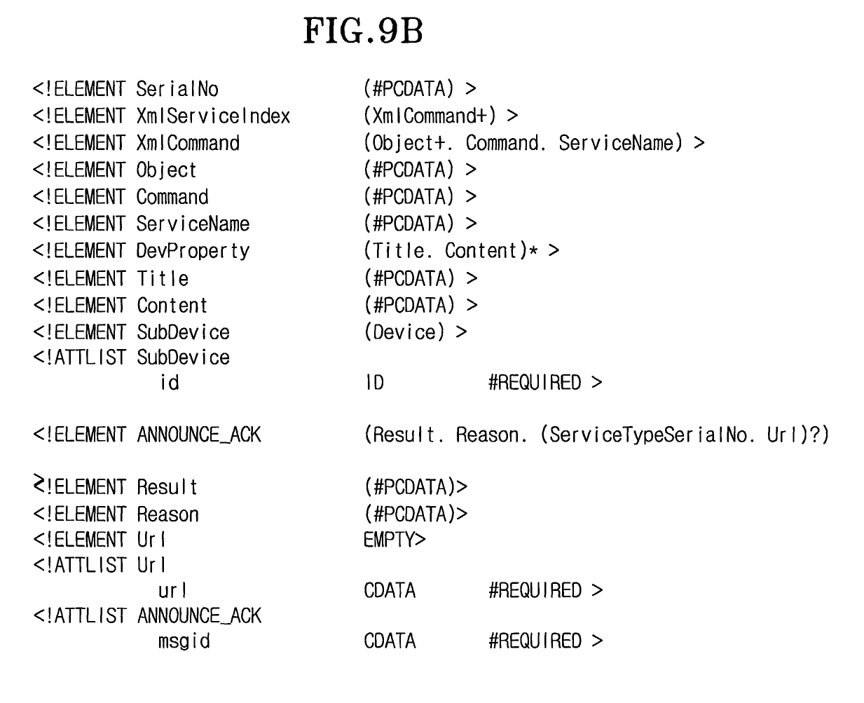

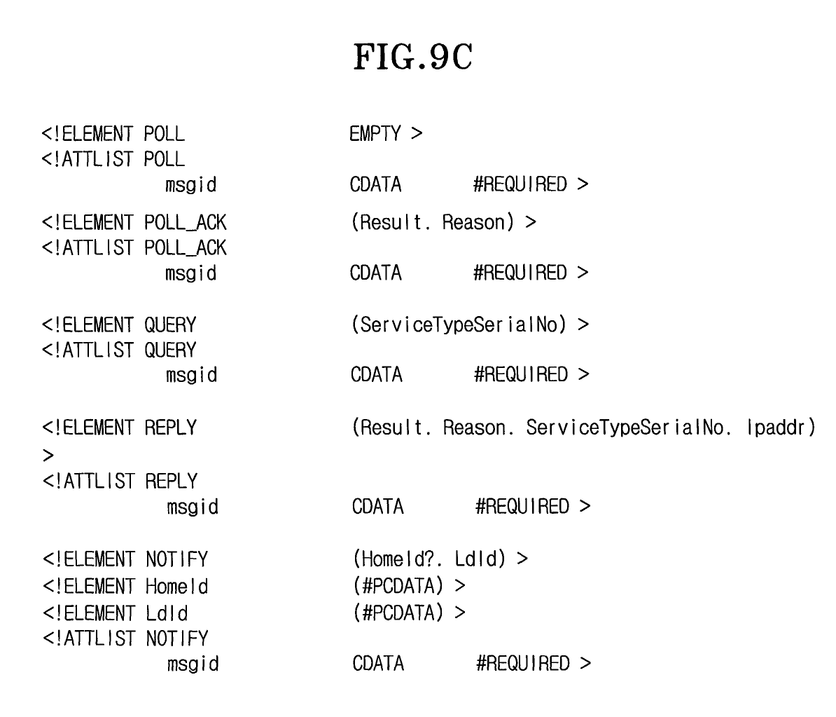

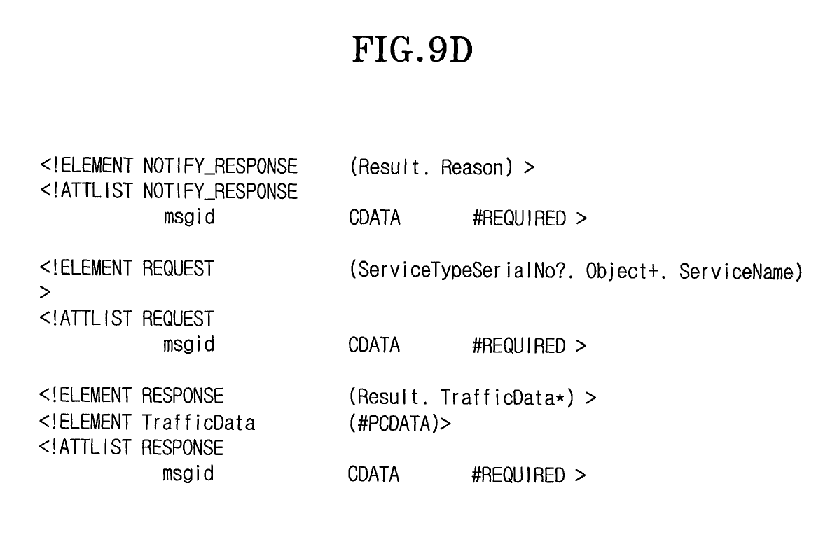

FIGS. 9A through 9D show program source code of an example of a master.dtd which is stored in the lookup server LS.

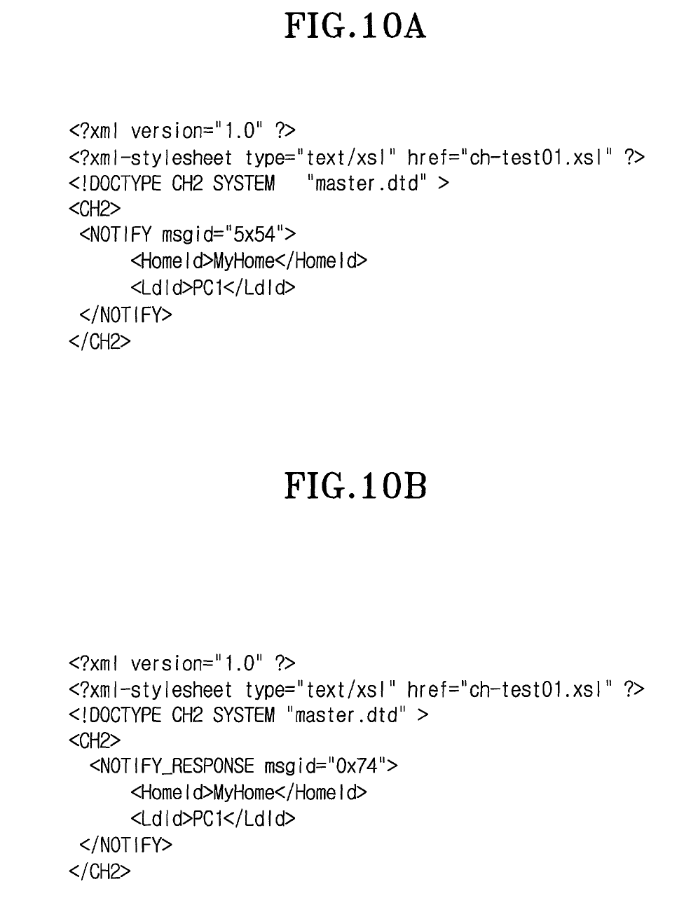

FIG. 10A shows source code of a service message, and FIG. 10B shows source code of a service response message.

A type of the service message is composed based upon contents of the master.dtd and XML encoded.

The response message about the service message includes result and reason.

The designated device is served only when the response message about the service message is: Result=SUCCESS; Reason=SERVICE_READY.

According to the system for serving the device in the home network and the method thereof, the devices connected in the home network can receive the services that are provided outside the home network.

It is apparent that the present invention is not restricted by the foregoing embodiments but can be varied by those skilled in the art without departing from the spirit of the invention. Therefore, the scope of the invention is not limited by the foregoing detailed description of the embodiment will be defined by the appended claims.

What is claimed is:

1. A system for externally providing a service to a specific device in a home network having a plurality of devices connected thereto, said system comprising:
a service receiving device which is registered to said home network and receives service; and
a remote service providing server in communication with said service receiving device for providing service when a service receptiveness of said service receiving device is confirmed, wherein said remote service providing server confirms the service receptiveness of said service receiving device by transmitting a service message to said service receiving device.

2. The system of claim 1, wherein said remote service providing server is adapted to store an ID (Identification) of said service receiving devices that are registered in said remote service providing server for the service.

3. The system of claim 1, wherein said remote service providing server is adapted to periodically output a push service which is received by said service receiving device as a specific service.

4. The system of claim 1, wherein the service message of said remote service providing server includes identification information for said service receiving device and said home network, to which said service receiving device is registered.

5. The system of claim 1, further comprising:
an Internet connection providing server adapted to receive the service message from said remote service providing server and transmit the service message to the home network designated by the service message; and
a lookup server which receives the service message from said Internet connection providing server and transmits the received service message to the device designated by the service message.

6. The system of claim 5, wherein said Internet connection providing server is adapted to store an ID (Identification) and a global IP address of the home network, which is registered in said Internet connection providing server.

7. The system of claim 5, wherein said lookup server in the home network is adapted to store an ID (Identification) and a dynamic IP address of the devices connected to the home network that are registered in said lookup server.

8. The system of claim 5, wherein said Internet connection providing server is adapted to confirm if the home network designated by the received service message is registered in said Internet connection providing server, and is adapted to convert the ID (Identification) of the home network designated by the service message to an IP address of the corresponding home network to transmit the converted service message.

9. The system of claim 5, wherein said lookup server is adapted to confirm if said service receiving device designated by the received service message is registered in said lookup server, and is adapted to convert the ID (Identification) of said service receiving device designated by the received service message to an IP address of the corresponding device.

10. A method for externally providing a service to a specific device in a home network having a plurality of devices connected thereto, said method comprising the steps of:
(i) transmitting a service message and a confirmation request from a remote service providing server to a service receiving device which is an intended recipient of the service; and
(ii) providing the service to said service receiving device when the confirmation request is affirmatively received.

11. The method of claim 10, further comprising the step of storing an ID (Identification) of a device which is registered for service.

12. The method of claim 10, further comprising the step of periodically providing a push service to selected service receiving devices.

13. The method of claim 10, wherein the service message is transmitted containing information about said service receiving device and a home network to which said service receiving device is registered.

14. The method of claim 10, further comprising the steps of:
(iii) receiving the service message in an Internet connection providing server and transmitting the received service message to a home network designated by the service message; and
(iv) receiving the service message from said Internet connection providing server in a lookup server and transmitting the received service message to a device designated by the service message.

15. The method of claim 14, further comprising the step of storing an ID (identification) and a global IP address of the home network which is registered in said Internet connection providing server.

16. The method of claim 14, further comprising the step of storing an ID (Identification) and a dynamic IP address of the devices which are registered in said lookup server of the home network.

17. The method of claim 14, wherein said step (iii) of receiving the service message in said Internet connection providing server comprises the steps of:
confirming if the home network designated by the received service message is registered in said Internet connection providing server; and
converting an ID (Identification) of the home network designated by the service message to an IP address of the corresponding home network to transmit the converted service message.

18. The method of claim 14, wherein said step (iv) of receiving the service message in a lookup server comprises the steps of:
confirming if said service receiving device designated by the received service message is registered in said lookup server; and
converting an ID (identification) of said service receiving device designated by the received service message to an IP address of the corresponding device.
